(19) United States
(12) Patent Application Publication
(10) Pub. No.: US 2007/0056943 A1
(43) Pub. Date: Mar. 15, 2007

(54) Apparatus and method for analyzing a welding process

(75) Inventor: Klaus Tenbrink, Freising (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/436,319

(22) Filed: May 18, 2006

(30) Foreign Application Priority Data
Sep. 12, 2005 (DE) 10 2005 043 583.1

(51) Int. Cl. B23K 9/10

(52) U.S. Cl. 219/130.01; 219/137.71

(57) ABSTRACT

A wire feed measuring device for wire feed in MIG or MAG welding is disclosed. The device includes a measuring head, which records the length of the fed wire, and a display device. The measuring head is wirelessly connected to the display device.

This application claims the priority of German Patent Document No. 10 2005 043 583.1, filed Sep. 12, 2005, the disclosure of which is incorporated by reference herein.

### BACKGROUND AND SUMMARY OF THE INVENTION

The invention relates to a wire feed measuring device for wire feed in MIG or MAG welding with a measuring head, which records the length of the fed wire, and a display device.

This type of device is known from Japanese Patent Document No. JP 632 212 02 for example. In this case, the welding wire is guided by on a reel and a counter reel pressed against it. With the movement of the welding wire in the feed direction, the reel is set into rotational motion. A meter connected directly to the reel directly displays the length of the feed.

The company of Linde markets a wire measuring device under the designation of DMG 2, which is structured in a similar way, but measures the wire length with a reel with a slot disk. The slot disk is illuminated and the changing light-dark signals are collected and forwarded to the electronics for evaluation. The device is built using conventional electronics. A cable connects the evaluation unit to the receiving unit. The evaluation unit is a single board computer, equipped with an 8085 processor.

A welding device is known from U.S. Pat. No. 6,051,805 in which a read device for the wire feed is connected via a cable to a numeric display.

The disadvantage of the three devices is that it is only possible to read the fed wire length in the direct vicinity of the receiving device.

However, the wireless transmission of information is known in the field of welding. Thus, International Publication No. WO 02/085566, European Patent Document No. EP 1 341 635 and U.S. Pat. No. 6,639,182 describe devices in which commands can be forwarded to a wire feed device via radio or infrared.

As a result, the present invention provides a device, which can display the wire feed, where the user is not forced to remain in the direct vicinity of the welding head.

In accordance with the invention, the connection between the measuring head and the display device is wireless. It is advantageous that the user can now remain anywhere in the room without having to be too close to the hot environment of the welding head that might be compromised by hazardous vapors.

The display device is preferably a hand-held device or a pocket computer (pocket PC, Palm, PDA, mobile phone), which is portable and has the displays required to display the measured values.

A measuring wheel is preferably arranged in the measuring head, which records the movement mechanically, optically, electrically, magnetically or incrementally, converts this movement into an electrical signal via a rotation indicator and transmits it with a transmission unit to an output device.

Transmission can take place using all currently known forms of short-range communication, such as infrared or radio, e.g., via Bluetooth, RFCom, OBEX, Service Discovery Protocol or Logical Link Control and adaptation protocols. Using Connex RF or short range radio frequency formats is just as possible.

Evaluation can take place either directly on the measuring head or in the display device. Therefore, a complete microcomputer with a corresponding memory and evaluation program can be located in the wire measuring head. The data are then forwarded to the hand-held device via the interface. In this case, it's possible to see the wire speed and the arc burning time in online operation for example. This is important information for the practice of adjustment and for monitoring quality. It is also possible to forward the data from the measuring head via the interface (Bluetooth) to a commercially available pocket PC or a hand-held device. An appropriate evaluation program then displays the online data from the wire measurement.

It permits the complete evaluation of the welding task as well as a determination of costs. A preliminary calculation can also take place here as well as in the hand-held device. The costs of a weld can be calculated in the device if the costs per cm are known.

Advantages of the invention are as follows below.

The precision of measurement is improved by using a rotation indicator. In particular, if an incremental rotational indicator is used that has 360 parts on its measuring disk so that 360 pulses are produced with one rotation, which corresponds for example to a wire feed of 5 cm, sufficient precision of the measurement can be guaranteed.

It is possible to record and evaluate complete work pieces by using modern microelectronics and a high recording density. Only individual seams could be observed with previous measuring heads, an addition of the seams and group formation of the welding task was not possible. The addition that was previously performed manually can be accomplished electronically.

Using a wireless radio connection (preferably a Bluetooth interface) makes cable-less measurement possible even in a difficult work environment.

The user can remain far away from the welding location.

Already existing laptops, Palm PCs, pocket PCs or mobile phones can be used by simply installing new software, thereby clearly reducing expenditures for equipment.

### BRIEF DESCRIPTION OF THE DRAWINGS

One exemplary embodiment of the invention is explained in greater detail on the basis of the drawings, in which:

FIG. 1 illustrates an assembled measuring head;

FIG. 2 shows a partially dismantled measuring head;

FIG. 3 shows a hand-held device; and

FIG. 4 shows a Palm as a display device.

### DETAILED DESCRIPTION OF THE DRAWINGS

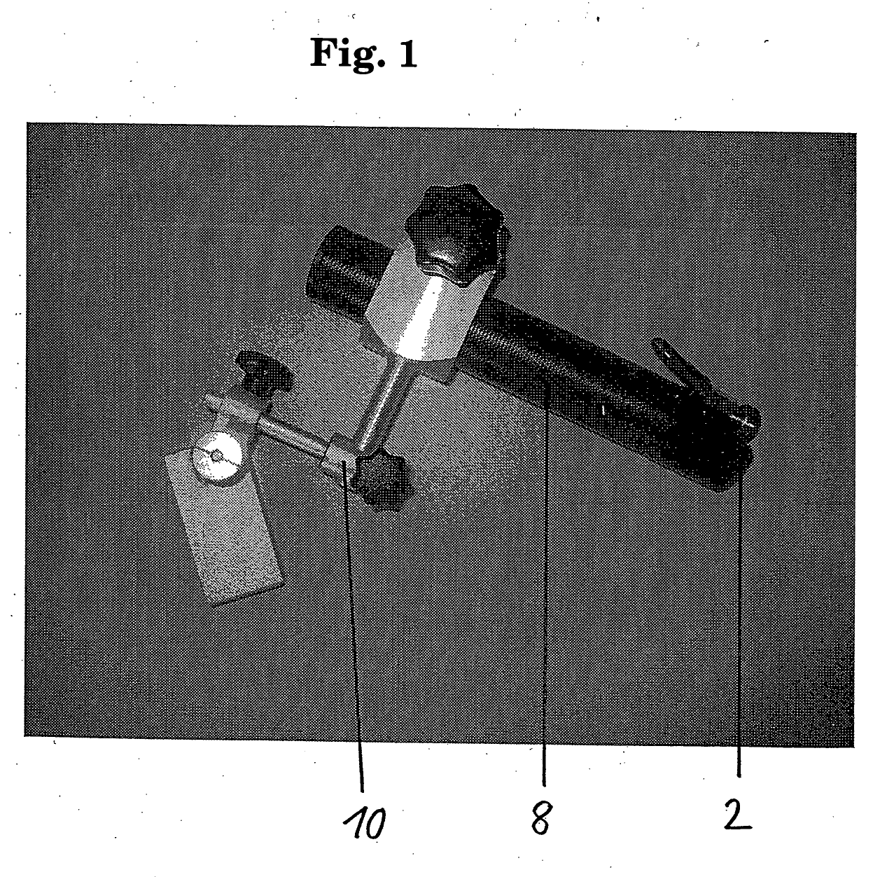

FIG. 1 shows an embodiment of the measuring head according to the invention, wherein the measuring head 2 is located in a housing 8, which can be aligned via an adjustable support 10 in such a way that the tip of the measuring head 2, on which the measuring wheel is situated, can be placed onto the wire that is passing by.

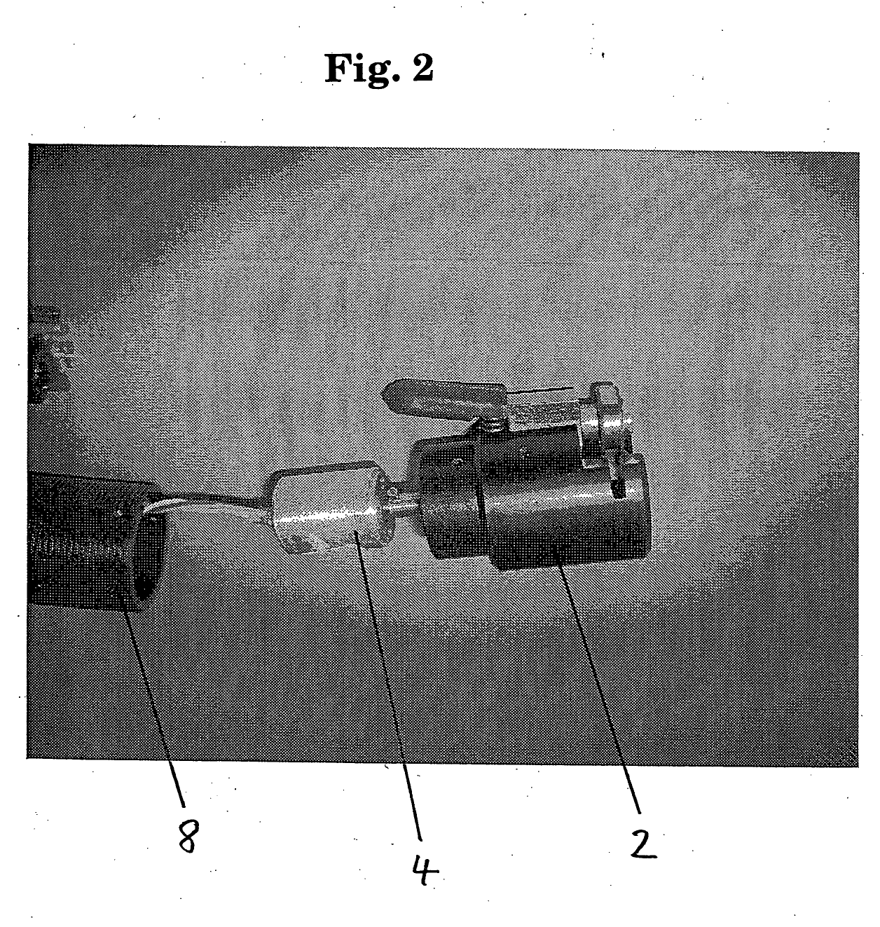

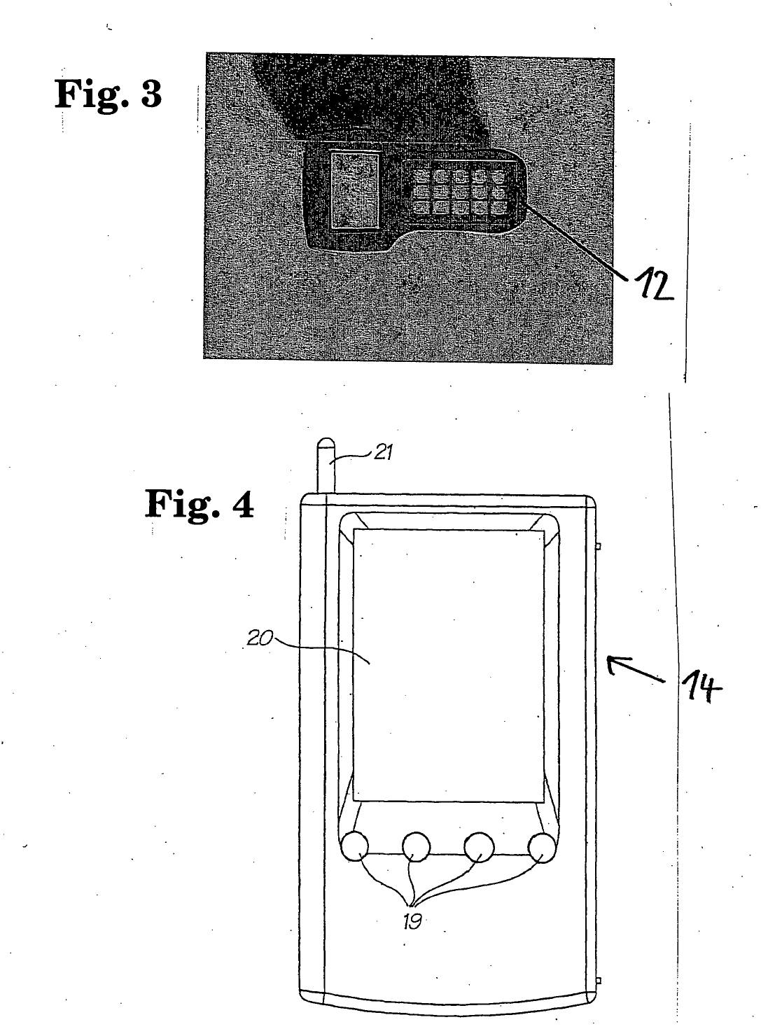

As FIG. 2 shows more clearly, the measuring head 2 has a clamp, with which a counter-reel can be placed on the wire that is passing through. This spring-loaded counter-reel presses the wire on a measuring wheel located in the interior of the measuring head 2, thereby avoiding slippage and therefore indication errors. The rotational movements of the measuring wheel are forwarded in the measuring head 2 to the rotation indicator 4, which measures the revolutions and converts them to electronic signals. These signals are forwarded by a transmitter to the electronics, which are located in the housing 8. The information (or the already evaluated measured values) goes wirelessly from the transmitter to the display device 12 or 14 as shown in FIGS. 3 and 4.

FIG. 3 shows a hand-held device with a display and several keys. The appropriate evaluation programs or displays can be turned on or off by inputting different numbers or letters on the keys.

FIG. 4 shows an alternative hand-held device, namely a commercially available pocket computer 14 with operating buttons 19, the display 20 and, if it also functions interactively with touch, the stylus 21.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A measuring device for wire feed in MIG or MAG welding with a measuring head, which records a length of a fed wire, and a display device, wherein the measuring head is wirelessly connected to the display device.

2. The measuring device according to claim 1, wherein the display device is a hand-held device or a pocket computer.

3. The measuring device according to claim 1, wherein the measuring head contains a measuring wheel or a rotation indicator.

4. The measuring device according to claim 1, wherein a transmission of the wireless connection takes place via Bluetooth, Connex RF or short range radio frequency format.

5. The measuring device according to claim 3, wherein the measuring head, the rotation indicator and transmission electronics are integrated into a housing.

6. The measuring device according to claim 1, wherein the measuring head is coupled to an adjustable support.

7. A welding process analysis device, comprising:
a measuring head for measuring a parameter associated with the welding process; and
a wireless transmitter coupled to the measuring head, wherein the transmitter wirelessly transmits a signal associated with the measured parameter to a display device.

8. The device according to claim 7, wherein the parameter is a length of a wire used in the welding process.

9. The device according to claim 7, further comprising a microcomputer, wherein the microcomputer performs an analysis of the parameter and wherein the signal represents a result of the analysis.

10. The device according to claim 9, wherein the parameter is a length of a wire used in the welding process and wherein the analysis includes calculating a cost of the length of the wire.

11. The device according to claim 9, wherein the parameter is a length of a wire used in the welding process and wherein the analysis includes adding a first length of the wire used for a first welding seam to a second length of the wire used for a second welding seam.

12. The device according to claim 7, wherein the parameter is a feed speed of the wire.

13. The device according to claim 7, wherein the parameter is an arc burning time.

14. A method for analyzing a welding process, comprising the steps of:
measuring a parameter associated with the welding process by a measuring head; and
wirelessly transmitting a signal associated with the measured parameter to a display device.

15. The method according to claim 14, wherein the parameter is a length of a wire used in the welding process.

16. The method according to claim 14, further comprising the step of performing an analysis of the measured parameter by a microcomputer and wherein the signal represents a result of the analysis.

17. The method according to claim 16, wherein the parameter is a length of a wire used in the welding process and wherein the analysis includes calculating a cost of the length of the wire.

18. The method according to claim 16, wherein the parameter is a length of a wire used in the welding process and wherein the analysis includes adding a first length of the wire used for a first welding seam to a second length of the wire used for a second welding seam.

19. The method according to claim 14, wherein the parameter is a feed speed of the wire.

20. The method according to claim 14, wherein the parameter is an arc burning time.
